(19) United States
(12) Patent Application Publication
(10) Pub. No.: US 2012/0306883 A1
(43) Pub. Date: Dec. 6, 2012

(54) LIQUID CHROMATOGRAPHY/MASS SPECTROMETRY DEVICE AND ANALYSIS METHOD USING LIQUID CHROMATOGRAPHY/MASS SPECTROMETRY DEVICE

(75) Inventors: Shinji Yoshioka, Hitachinaka (JP); Hiromichi Yamashita, Hitachinaka (JP)

(73) Assignee: HITACHI HIGH-TECHNOLOGIES CORPORATION, Tokyo (JP)

(21) Appl. No.: 13/508,883

(22) PCT Filed: Oct. 28, 2010
(86) PCT No.: PCT/JP2010/069147

§ 371 Date: May 9, 2012

(30) Foreign Application Priority Data
Nov. 13, 2009 (JP) 2009-259395

(51) Int. Cl. G06T 11/20

(52) U.S. Cl. 345/440

(57) ABSTRACT

The present invention provides a liquid chromatography/mass spectrometry device which enables similarity between an authentic sample and a sample to be compared to be easily recognized on mass spectrum data obtained from each of the authentic sample and the sample to be compared, and also enables each analysis result to be accurately recognized by making unnecessary peaks not to be displayed. For this purpose, the device displays the ionic peak strengths of the mass spectrum data obtained from each of the authentic sample and the sample to be compared, on a map which has a retention time and a mass-to-charge ratio as axes, with the use of light and dark. Furthermore, the device displays only a peak having a designated strength thereon while distinguishing the peak from other peaks, and also provides a map which displays only the peak thereon.

### TECHNICAL FIELD

The present invention relates to a liquid chromatography/mass spectrometry device, and also relates to an analysis method using the liquid chromatography/mass spectrometry device.

The present invention relates to an analysis technology, for instance, of: measuring such components derived from many protein species as in a sample in which a protein component that has been extracted from a cell, blood plasma or the like has been digested with the use of an enzyme to be formed into peptide fragments, with a liquid chromatography/mass spectrometry device; and quantitatively comparing/analyzing each component that is detected, between different samples, with the use of a three-dimensional data in which a mass spectrum that is obtained from the measurement result and is formed of ionic strengths with respect to mass-to-charge ratios has been accumulated at each of retention times.

### BACKGROUND ART

When components in a sample in which a plurality of components coexist are analyzed with the use of a liquid chromatography/mass spectrometry device, the components can be identified by sequentially observing ions derived from the components in the sample. Then, a three-dimensional data can be obtained by producing a mass spectrum which expresses ionic strength with respect to a mass-to-charge ratio (m/z) of the ion, and accumulating the mass spectrum at each of retention times. Such an analysis is attempted as to quantitatively compare the components contained in two samples with the use of this three-dimensional data (for instance, see Patent Document 1).

In mass spectrometry, many ions derived from a plurality of the components are detected in many cases, and as for the respective ions, many ions having different valencies according to the structural characteristics are detected, in many cases. Particularly, in the case of a mass spectrometry device using an electro spray ion source (Electro Spray Ion Source: being abbreviated as ESI) having such characteristics that useful polyvalent ions of protein and peptide are easily produced, a plurality of ions having valencies of 2 or more are detected.

When the ions thus having many valencies though being one ion are plotted on a graph of the mass spectrum simply in order of mass-to-charge ratios, it is difficult to easily and visually distinguish the ions from a single charge ion of a low-molecular ion such as a contaminant component. In addition, it is important in an analysis for post-translational modification represented by a phosphorylated compound and the like to confirm a peak group having a particular mass difference. In the case of phosphorylated protein, for instance, in peptide fragments which have been subjected to enzyme digestion treatment, a mass difference even of 98 is confirmed between phosphorylated peptide and non-modified peptide. Also concerning the peak group thus having the particular mass difference, when the sample in which a plurality of the components coexist is measured with the use of the liquid chromatography/mass spectrometry device, many peak groups are detected, and it is difficult to visually extract a difference between the peak groups.

As is disclosed in the above described Patent Document 1, a method is known which color-codes a difference between ionic strengths or a value of a ratio of ionic strengths, an ionic strength existing in only one sample, or both of the ionic strengths for every sample, and displays the color-coded ions as maps of light and dark for the corresponding retention time and the mass-to-charge ratio between two samples. However, in the description of Patent Document 1, such a technique is proposed as to display all detected ions on a map, color-code differences of the ionic strengths between different samples, the values of ratios of the ionic strengths or the like, and display the color-coded ions on the map of light and dark. According to this technique, ions other than the ion to be actually aimed are displayed, and accordingly the number of the displayed ion peaks results in being an enormous number. Therefore, the technique needs to be improved for practical use. In addition, when the ion peak having the specific mass-to-charge ratio is identified, it is difficult to extract the ion having the specific valency out of a plurality of the ion peaks, by only simply displaying a map concerning the mass-to-charge ratios for all ions. In addition, it is also difficult to extract the peak group having the particular peak difference as described above.

### CITATION LIST

### Patent Literature

Patent document 1: JP Patent Publication (Kokai) No. 2008-249440 A

SUMMARY OF INVENTION

### Technical Problem

An object of the present invention is to provide a liquid chromatography/mass spectrometry device which enables similarity between an authentic sample and a sample to be compared to be easily recognized on mass spectrum data obtained from each of the authentic sample and the sample to be compared, and also enables each analysis result to be accurately recognized by making unnecessary peaks not to be displayed.

### Solution to Problem

In order to achieve the above described object, the embodiment of the present invention has a structure of providing a map which has a retention time and a mass-to-charge ratio as axes and displays the ionic peak strengths of the mass spectrum data obtained from at least two samples thereon with the use of light and dark, and also providing a map that displays only the peak having a designated strength, which has been distinguished from other peaks, and displays only the peak thereon.

### Advantageous Effects of Invention

According to the present invention, the similarity between the authentic sample and the sample to be compared for mass spectrum data obtained from each of the authentic sample and the sample to be compared can be easily recognized, and also an individual analysis result can be accurately recognized because unnecessary peaks are not displayed.

### BRIEF DESCRIPTION OF THE DRAWINGS

FIG. 1 is a block diagram illustrating a schematic structure of a liquid chromatography/mass spectrometry device.

FIG. 2 is a flow chart illustrating a flow of processing when a map is displayed on a display device.

FIG. 3 is a screen view illustrating a box for valency designation, which is displayed on the display device.

FIG. 4 is a screen view illustrating examples of map display, which are displayed on the display device.

FIG. 5 is a flow chart illustrating a flow of processing when the map is displayed on the display device.

FIG. 6 is a screen view illustrating a box which is displayed on the display device and into which the mass number of a peak is input.

FIG. 7 is a screen view illustrating examples of the map display, which are displayed on the display device.

### DESCRIPTION OF EMBODIMENTS

An embodiment according to the present invention will be described below with reference to the drawings. However, the embodiment which will be described later is one example for describing the content of the present invention. Accordingly, the present invention is not limited to the embodiment which will be described later.

### Embodiment

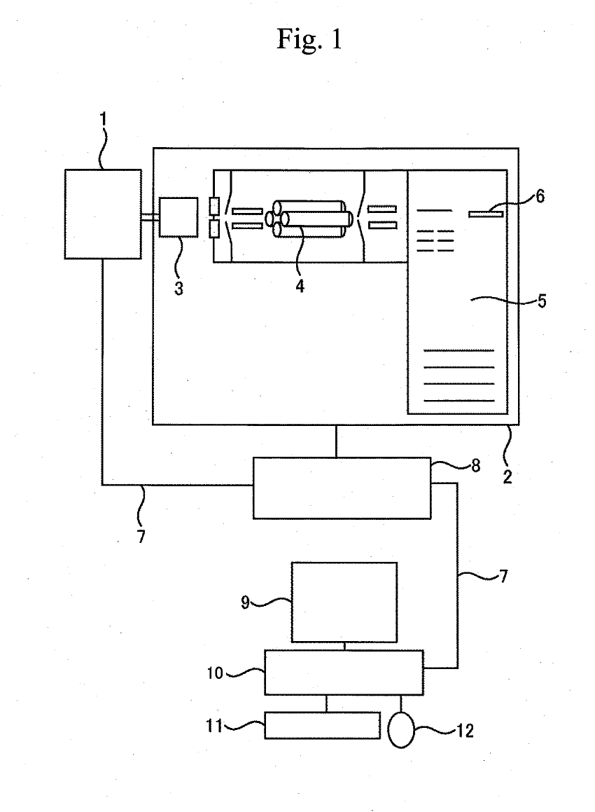

FIG. 1 is a block diagram illustrating a schematic structure of a liquid chromatography/mass spectrometry device. Many of protein samples are fragmented by enzyme digestion to be formed into a peptides sample, and then the peptides are separated by a liquid chromatography device 1. The components of the peptides which have been separated by the liquid chromatography device 1 are introduced into a main body 2 of a mass spectrometry device, and are ionized by an ion source 3. The ion source 3 which is an ion generation section employs the above described electro spray ion source ESI having characteristics of tending to easily generate useful polyvalent ions of protein and peptide. The ESI is a soft ionization method which does not give a damage to an aimed component to be ionized in the ionization process, and has characteristics of easily generating polyvalent ions derived from a molecular weight of the component of the protein and the peptide. For this reason, it becomes possible to determine the peptide components from the contaminant components on the basis of a difference of the valencies of the components by adopting the ESI, because a low-molecular component such as the contaminant component has a high tendency to be detected in a form of a single charge ion.

An ion trap section 4 is provided in the rear stage of the ion source 3. This ion trap section 4 conducts ion separation and selective sweeping for the mass, in order to enhance spectral sensitivity. The ions which have been discharged from the ion trap section 4 are subjected to high resolution measurement with the use of a time-of-flight type mass spectrometry section (Time of Flight, which will be abbreviated as TOF) 5, and the ions are detected by an ion detector 6.

Here, the time-of-flight type mass spectrometry section has been shown as one example, but another device can be used in the present invention as long as the device can conduct the high resolution measurement of the mass spectrum. For instance, the present invention can be applied to a device which adopts a Fourier-transform-ion-cyclotron-resonance (which is abbreviated to FT-ICR) mass analyzer.

The liquid chromatography device 1, each analytical instrument in the main body 2 of the mass spectrometry device, a control device 8 and a data-processing device 10 are connected to each other through a signal line 7, and the instruments can be controlled and the data information can be accumulated through the signal line 7. In addition, the data-processing device 10 is usually constituted by a personal computer which is provided with a processor and a storage device, and is connected to a display device 9 which is an output device and to a keyboard 11 and a mouse 12 which are input devices.

In this structure, the time-of-flight type mass spectrometry section 5 continuously acquires data which becomes a basic data of the mass spectrum while synchronizing with a starting time of the separation for the sample components by the liquid chromatography device 1, and transmits the signals showing the data to the control device 8. The control device transmits the mass spectrum which shows a relationship of the ionic strength with respect to a mass-to-charge ratio, to the data-processing device 10 at each of retention times at which the mass spectrum has been observed, and accumulates the mass spectrum.

In the present embodiment, the mass spectrum data which have been obtained comprehensively are developed on coordinate axes of the retention time and the mass-to-charge ratio (m/z), and each ionic strength is displayed on a map of the display device 9, with the use of light and dark. The liquid chromatography/mass spectrometry device has a plural types of data display functions so that an operator can extract only a component having the aimed valency as a map display of ions having each valency and a map display of ions having a particular valency, from the map display of all spectra data, by using the above described properties that the ions have different valencies, when displaying the map. Thereby, the operator can select a display from which the operator can visually and easily decide the aimed ion, and can easily determine a difference between two samples. Specific examples of the display functions will be described below.

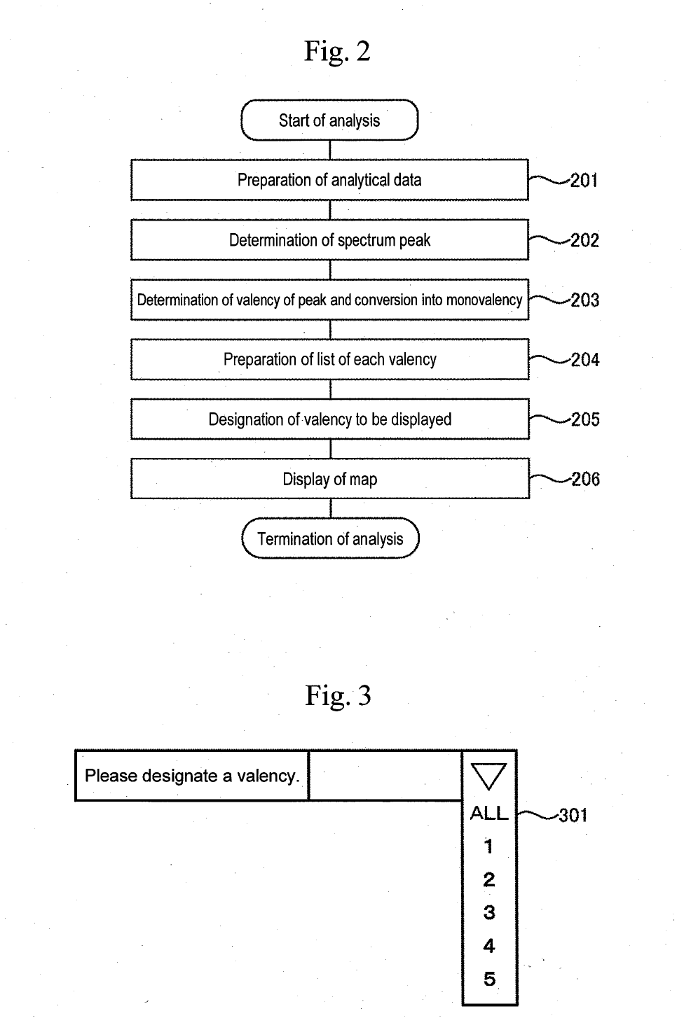

FIG. 2 is a flow chart illustrating a flow of processing when a map is displayed on a display device 9. Each step is conducted by the processor according to a program which has been previously stored in the storage device of the data-processing device 10.

When analysis is started, the data-processing device 10 prepares an analytical data to be used in the processing from the measurement result of a sample to be compared (step 201). Subsequently, the data-processing device 10 determines all spectrum peaks which have been detected on a mass spectrum, from the prepared analytical data, and removes a noise peak (step 202). After having removed the noise peak, the data-processing device 10 confirms isotopic peaks in the remaining peaks, and determines the valencies of the respective peaks. In addition, at this time, the data-processing device 10 converts the peak of which the valency has been determined into a single charge, and calculates the molecular weight (step 203). After having finished the determination of the valency, the data-processing device 10 arranges spectrum peaks on each valency into groups, and prepares a list (step 204). After that, the operator designates one valency or a plurality of valencies to be displayed on the map, by using the input device such as the keyboard 11 and the mouse 12, which is connected to the data-processing device 10 (step 205). The data-processing device 10 recalculates the map display, and displays the map on the display device 9 (step 206).

FIG. 3 is a screen view illustrating one example of a box for valency designation, which is displayed on the display device when the valency is designated in step 205 in FIG. 2. The operator designates the valency, for instance, by positioning a cursor displayed on the screen, onto the number which is displayed in the box 301, and clicking the button of the mouse 12. When “ALL” is designated, all peaks are selected.

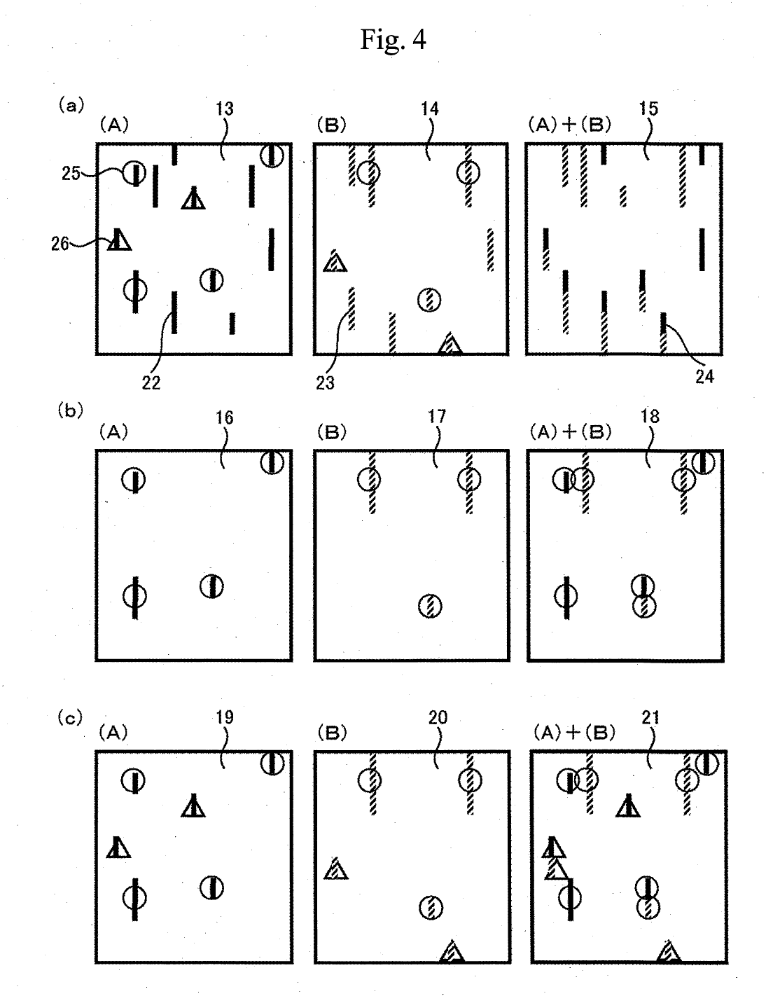

FIG. 4 is a screen view illustrating examples of map display, which are displayed on the display device 9. One example of screen displays appearing when a peak group having a particular valency is displayed will be described below. Each viewer illustrated in FIG. 4 is a view displaying all spectrum peaks in the measurement data on a two-dimensional map which takes retention time for an ordinate axis, and a mass-to-charge ratio for an abscissa axis. Each view displays a three-dimensional data so as to be easily and visually recognized, by expressing the ionic strengths with the use of light and dark.

In FIG. 4(a), (A) in the left side is a display example of an authentic sample map 13, (B) in the middle is a display example of a comparison sample map 14, and (A)+(B) in the right side is a display example of a comparison analysis result map 15. A difference among individual ionic strengths is displayed with the use of light and dark, which are displayed on the authentic sample map 13, on the comparison sample map 14 and on the comparison analysis result map 15. However, different colors between the maps are adopted for the color for plotting the ionic strength in each map so that the operator can easily determine the difference between the maps. For instance, in the authentic sample map 13 corresponding to (A) in the left side, a bar 22 illustrating the ionic strength shall be expressed by a red color, and in the comparison sample map 14 corresponding to (B) in the middle, a bar 23 illustrating the ionic strength shall be expressed by a green color. In this case, in the comparison analysis result map 15 corresponding to (A)+(B) in the right side, a bar 24 illustrating the ionic strength is displayed so that the ionic strength of the authentic sample map 13 corresponding to (A) and the ionic strength of the comparison sample map 14 corresponding to (B) in the middle are overlapped. In other words, the bar 24 illustrating the ionic strength is expressed by both of the red color and the green color. In the portion in which the ionic strengths are overlapped, a portion in which the ion has the same strength is made to be displayed by the original color. Alternatively, display colors for peaks of one ionic strength are changed according to the strengths. Specifically, in the authentic sample map 13 corresponding to (A) in the left side, a portion in which the ionic strength is large among the bars 22 illustrating the ionic strengths is expressed by the red color, and the colors are changed from an orange color to a yellow color as the strength decreases. Then, the method is convenient when the operator wants to pay attention only to a portion in which the ionic strength is large.

When the sum of the ionic strengths is employed for the display of the ionic strength in the comparison analysis result map 15 corresponding to (A)+(B) in the right side, if the peaks of two ionic strengths are almost overlapped, the ionic strength becomes twice and exceeds the upper limit of color-coding display, and the initial setting for color-coding display needs to be restarted. On the other hand, when the difference of the ionic strengths is employed for the display of the ionic strength in the comparison analysis result map 15, if the peaks of two ionic strengths are almost overlapped, the ionic strength becomes zero in the vicinity of the center at which the ionic strengths are overlapped, and the display becomes a state in which the ion strength is not colored. Because of this, it is not determined whether the ionic strength has been high or not.

The data-processing device makes the result of the valency which has been determined in the step 203 in FIG. 2 to be further displayed on the map with a symbol. For instance, a round mark 25 displayed on the authentic sample map 13 of (A) in FIG. 4(a) denotes the peak of ionic strength which has been determined as a divalent ion, and a triangle mark 26 denotes the peak of ionic strength which has been determined as a trivalent ion. The data-processing device enables the operator to select and display the determined valency, by using these marks.

When the divalent ion is designated in a valency-designating screen as illustrated in FIG. 3 with the input device, for instance, such as the keyboard 11 and the mouse 12 illustrated in FIG. 1, the screen is changed to the display as illustrated in FIG. 4(b). FIG. 4(b) illustrates an example in which only the peaks of ionic strengths of a divalent ion are displayed. In the authentic sample map 16 of (A) in FIG. 4(b), only the peaks of ionic strengths are displayed, which are denoted by the round mark 25 out of those in the authentic sample map 13 in FIG. 4(a). In addition, in the comparison sample map 17 of (B) in FIG. 4(b), only the peaks of ionic strengths are displayed, which are denoted by the round mark 25 out of those in the comparison sample map 14 in FIG. 4(a). In addition, in the comparison analysis result map 18 of (A)+(B) in FIG. 4(b), only the peaks of ionic strengths are displayed, which are denoted by the round mark 25 out of those in the authentic sample map 16 and the comparison sample map 17 in FIG. 4(b).

Furthermore, the data-processing device also enables only the peaks of ionic strengths of both of the divalent ion and the trivalent ion to be displayed, by using these marks. When the operator designates the divalent ion and the trivalent ion in a valency-designating screen as illustrated in FIG. 3, with the input device, for instance, such as the keyboard 11 and the mouse 12 as illustrated in FIG. 1, the screen is changed to the display as illustrated in FIG. 4(c). FIG. 4(c) illustrates an example in which only peaks of ionic strengths of the divalent ion and the trivalent ion are displayed. In the authentic sample map 19 illustrated in (A) in FIG. 4(c), only the peaks of ionic strengths are displayed, which are each denoted by the round mark 25 and by the triangle mark 26 out of those in the authentic sample map 13 in FIG. 4(a). In addition, in the comparison sample map 20 illustrated in (B) in FIG. 4(c), only the peaks of ionic strengths are displayed, which are each denoted by the round mark 25 and by the triangle mark 26 out of those in the comparison sample map 14 in FIG. 4(a). In addition, in the comparison analysis result map 21 of (A)+(B) in FIG. 4(c), only the peaks of ionic strengths are displayed, which are each denoted by the round mark 25 and by the triangle mark 26 out of the authentic sample map 19 and the comparison sample map 20 in FIG. 4(c).

Such a function as to make only the designated valency displayed on the map eventually enables only the aimed component derived from protein, peptide and the like to be selectively displayed, and accordingly is very useful. In addition, the map of the comparison analysis result also shows a result of having removed the peak of ionic strength derived from the contaminant component and the like. Because of this, as for the comparison analysis result as well, the operator easily and visually determines the similarity between the two samples, and can prevent false recognition.

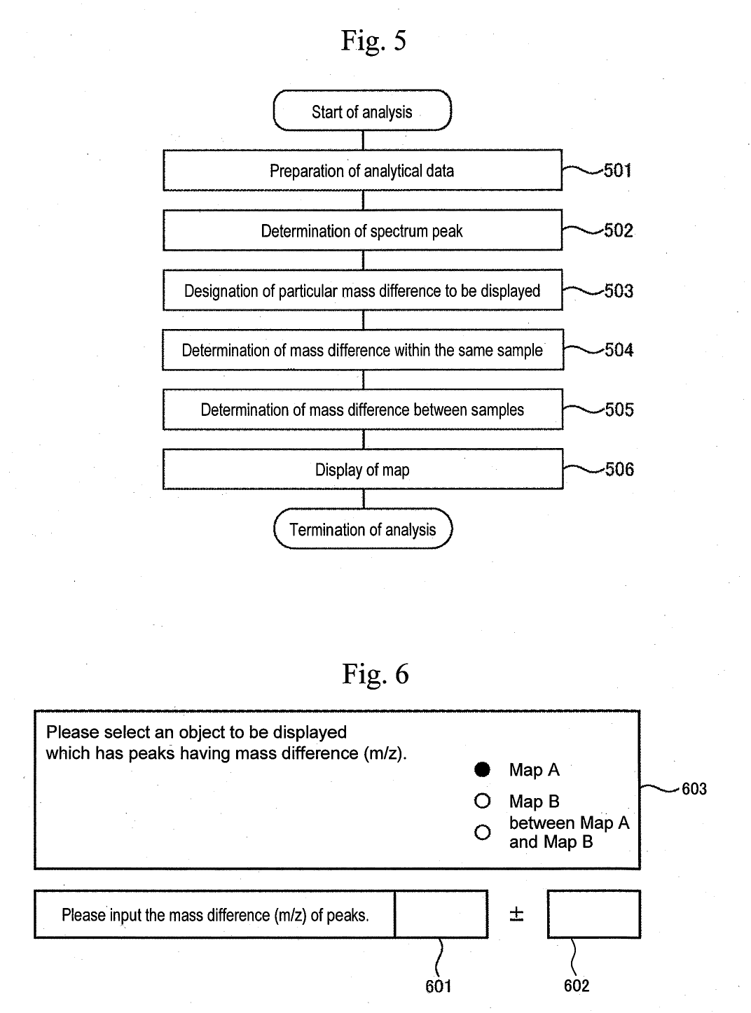

FIG. 5 is a flow chart illustrating a flow of processing when the map is displayed on the display device 9, and illustrates the flow of processing when a peak group having a particular mass difference is extracted. Here, the mass difference is expressed by the difference of a mass-to-charge ratio (m/z). The processor conducts each step according to a program which has been previously stored in the storage device of the data-processing device 10. When analysis is started, the data-processing device 10 prepares a data to be used in the processing from the measurement result of a sample to be compared (step 501). Subsequently, the data-processing device 10 determines all spectrum peaks which have been detected on a mass spectrum, on the basis of the prepared data, and removes a noise peak (step 502). After having removed the noise, the data-processing device 10 prepares a peak list for all of the peaks which have been determined to be a peak. After that, the operator designates the mass difference for extracting the peak group which has the particular mass difference (step 503). The data-processing device extracts a list of the peak groups which match with the particular mass difference that has been designated, from the list of the peaks which have been determined to be the peak, and prepares the list. At this time, the data-processing device extracts the peak group in the same sample (step 504), and extracts the peak group between the samples (step 505). After that, the operator designates whether the peak group having the particular mass difference to be displayed on the map is displayed for the same sample or between the samples, by using the input device of the keyboard 11, the mouse 12 or the like, which is connected to the data-processing device 10. Then, the data-processing device recalculates the map display on the basis of the designation result, and displays the result on the map on the display device 9 (step 506).

FIG. 6 is a screen view illustrating one example of boxes which are displayed on the display device and into which the mass number of a spectrum peak is input. In the screen displayed on the display device according to Step 503 illustrated in FIG. 5, the operator inputs the central value of the number of the difference between the mass-to-charge ratios (m/z) into a box 601 in the left side, and inputs an allowable range into a box 602 in the right side, with the keyboard 11. When “98” is input into the box 601 in the left side, and the “0.1” is input into the box 602 in the right side, for instance, a peak in a range from 97.9 to 98.1 is extracted.

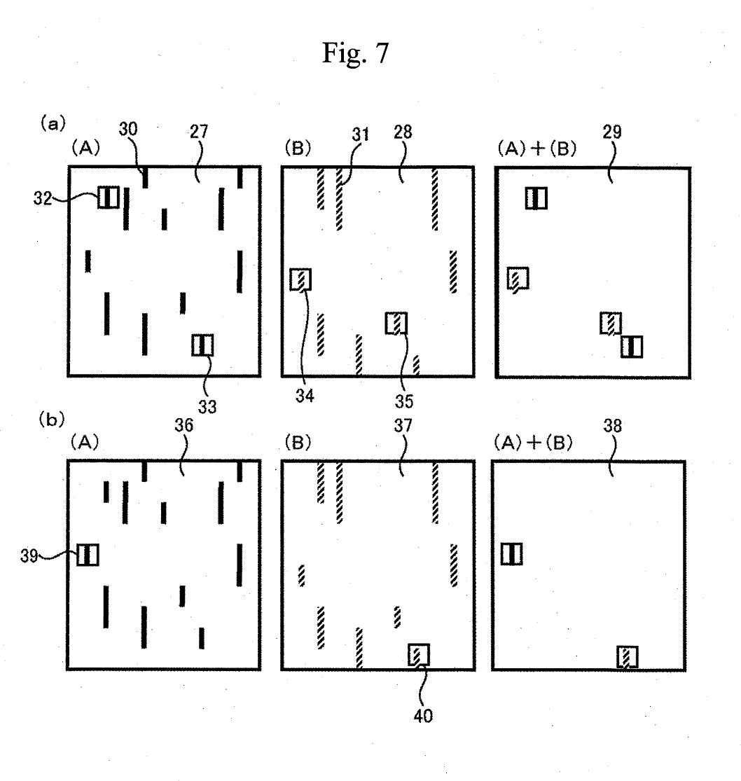

Next, an example of the screen display when the peak group having the particular mass difference is displayed will be described below. FIG. 7 is a screen view illustrating an example of the map displays which are displayed on the display device 9 in the same way as in FIG. 4. The basic screen of the map display is a screen in which all spectrum peaks in the measurement data are displayed on a two-dimensional map which has a retention time as an ordinate axis and a mass-to-charge ratio as an abscissa axis, similarly to that in FIG. 4. Each view displays a three-dimensional data so as to be easily and visually recognized, by expressing the difference of the ionic strength with the use of light and dark.

In FIG. 7(a), (A) in the left side is an authentic sample map 27, (B) in the middle is a comparison sample map 28, and (A)+(B) in the right side is a comparison analysis result map 29. By putting the check mark on the map A in a map selection box 603 illustrated in FIG. 6, the operator can designate the mass difference between the peaks in the authentic sample map 27 in FIG. 7(a). Similarly, by putting the check mark on the map B in the map selection box 603, the operator can designate the mass difference between the peaks in the comparison sample map 28 in FIG. 7(a). The differences among individual ionic strengths which are displayed on the authentic sample map 27, the comparison sample map 28 and the comparison analysis result map 29 are displayed with the use of light and dark, but different colors between the maps are adopted as a color for plotting the ionic strength in each map so that the operator can easily determine the difference between the maps. For instance, in the authentic sample map 27 corresponding to (A) in the left side, a bar 30 illustrating the ionic strength shall be expressed by a red color, and in the comparison sample map 28 corresponding to (B) in the middle, a bar 31 illustrating the ionic strength shall be expressed by a green color. In this case, in the comparison analysis result map 29 corresponding to (A)+(B) in the right side, a bar illustrating the ionic strength is displayed with the use of both of the colors.

In the authentic sample map 27 of (A) in the left side of FIG. 7(a), square marks 32 and 33 are displayed. In the step 503 in FIG. 5, the data-processing device extracts the peak group having a particular mass difference, and the operator designates the particular mass difference. In the steps 504 and 505, the mass differences are determined. As a result, the peak groups having the designated mass difference are extracted.

Also in the comparison sample map 28 of (B) in the middle of FIG. 7(a), the peak groups having the mass difference which has been designated in the step 504 in FIG. 5 are denoted by the square marks 34 and 35. In the comparison analysis result map 29 of (A)+(B) in the right side of FIG. 7(a), only the peak groups of which the mass difference has been designated are displayed together with the square marks. Such a display enables the operator to recognize only a peak having a mass difference smaller than the designated one.

In a standard sample map 36 corresponding to (A) in the left side illustrated in FIG. 7(b) and a comparison sample map 37 corresponding to (B) in the middle of FIG. 7(b), the mass difference between the two samples is determined according to the step 505 in FIG. 5, and the peak groups are denoted by the corresponded square mark 39 and the square mark 40. When the operator puts the check mark on the map between A and B in the map selection box 603 illustrated in FIG. 6, the data-processing device designates a difference between the mass-to-charge ratio m/z of the spectrum peak in the authentic sample map 36 in FIG. 7(b) and the mass-to-charge ratio m/z of the spectrum peak in the comparison sample map 37, and can display the corresponding peak on the comparison analysis result map 38.

The above described embodiment of the present invention can display all spectrum peaks in the measurement data on a two-dimensional map which has a retention time as an ordinate axis and a mass-to-charge ratio as an abscissa axis, and can display a three-dimensional data so as to be easily and visually recognized, by expressing the difference between the ionic strengths with the use of light and dark. In addition, the data-processing device has also such a two-dimensional map provided therein as to put a symbol, denotation or the like only onto a necessary spectrum peak needed by the operator, display the peak while distinguishing the peak from other peaks and display only the peak thereon, and thereby, the operator can easily recognize the similarity between the authentic sample and the sample to be compared. Furthermore, the data-processing device does not display unnecessary peaks, and thereby eventually enables the operator to accurately recognize individual analysis results.

### REFERENCE SIGNS LIST

1 Liquid chromatography device
2 Main body of mass spectrometry device
3 Ion source
4 Ion trap section
5 Time-of-flight mass spectrometry section
6 Ion detector
8 Control device
9 Display device
10 Data-processing device
11 Keyboard
12 Mouse

1. A liquid chromatography/mass spectrometry device comprising:
a liquid chromatograph device which separates a sample;
an ion source section which ionizes components separated in the liquid chromatograph device;
a mass spectrometer which conducts mass dispersion of the components ionized in the ion source section to obtain mass spectrum data; and
a data-processing device which displays each of the mass spectrum data of an authentic sample and a sample to be compared which have been used as the sample, on a display device, wherein
the data-processing device displays ionic peak strengths of the mass spectrum data to be displayed on the display device with the use of light and dark, on a map which has a retention time and a mass-to-charge ratio as axes, and displays only a peak having a designated strength while distinguishing the peak from other peaks.

2. The liquid chromatography/mass spectrometry device according to claim 1, wherein the data-processing device displays the ionic peak strength of the authentic sample and the ionic peak strength of the sample to be compared on the map with the use of different colors.

3. The liquid chromatography/mass spectrometry device according to claim 1, wherein the data-processing device displays a peak having a designated valency out of the mass spectrum data, while distinguishing the peak from other peaks, on the map.

4. The liquid chromatography/mass spectrometry device according to claim 1, wherein the data-processing device displays only a peak having a designated valency out of the mass spectrum data, on the map.

5. The liquid chromatography/mass spectrometry device according to claim 1, wherein the data-processing device displays a plurality of peaks having a designated difference of a mass-to-charge ratio out of the mass spectrum data, while distinguishing the peaks from other peaks, on the map.

6. The liquid chromatography/mass spectrometry device according to claim 1, wherein the data-processing device displays only a plurality of peaks having a designated difference of a mass-to-charge ratio out of the mass spectrum data on the map.

7. The liquid chromatography/mass spectrometry device according to claim 1, wherein the data-processing device displays a peak of the authentic sample and a peak of the sample to be compared which have a designated difference of the mass-to-charge ratio out of the mass spectrum data, while distinguishing the peaks from other peaks, on the map.

8. The liquid chromatography/mass spectrometry device according to claim 1, wherein the data-processing device displays only a peak of the authentic sample and a peak of the sample to be compared which have a designated difference of the mass-to-charge ratio out of the mass spectrum data, on the map.

9. An analysis method with the use of a liquid chromatography/mass spectrometry device which comprises:
a liquid chromatograph device that separates a sample;
an ion source section that ionizes components separated in the liquid chromatograph device;
a mass spectrometer that conducts the mass dispersion of the components ionized in the ion source section to obtain mass spectrum data; and
a data-processing device that displays each of mass spectrum data of an authentic sample and a sample to be compared which have been used as the sample, on a display device, wherein
the data-processing device displays ionic peak strengths of the mass spectrum data to be displayed on the display device with the use of light and dark, on a map which has a retention time and a mass-to-charge ratio as axes, and displays only a peak having a designated strength while distinguishing the peak from other peaks.

10. An analysis method with the use of a liquid chromatography/mass spectrometry device, comprising the steps of:
separating a sample in a liquid chromatograph device; ionizing separated components; conducting the mass dispersion of the ionized components to obtain mass spectrum data; and making a display device display each of the mass spectrum data of an authentic sample and a sample to be compared which have been used as the sample, wherein
the ionic peak strengths of the mass spectrum data to be displayed on the display device are displayed on a map which has a retention time and a mass-to-charge ratio as axes, with the use of light and dark, and only a peak having the designated strength is displayed so as to be distinguished from other peaks.

11. The analysis method with the use of the liquid chromatography/mass spectrometry device according to claim 10, wherein the ionic peak strength of the authentic sample and the ionic peak strength of the sample to be compared are displayed on the map with the use of different colors.

12. The analysis method with the use of the liquid chromatography/mass spectrometry device according to claim 10, wherein a peak having a designated valency out of the mass spectrum data is displayed on the map so as to be distinguished from other peaks.

13. The analysis method with the use of the liquid chromatography/mass spectrometry device according to claim 10, wherein only a peak having a designated valency out of the mass spectrum data is displayed on the map.

14. The analysis method with the use of the liquid chromatography/mass spectrometry device according to claim 10, wherein a plurality of peaks having a designated difference of the mass-to-charge ratio out of the mass spectrum data are displayed on the map so as to be distinguished from other peaks.

15. The analysis method with the use of the liquid chromatography/mass spectrometry device according to claim 10, wherein only a plurality of peaks having a designated difference of a mass-to-charge ratio out of the mass spectrum data are displayed on the map.

16. The analysis method with the use of the liquid chromatography/mass spectrometry device according to claim 10, wherein a peak of the authentic sample and a peak of the sample to be compared which each have a designated difference of the mass-to-charge ratio out of the mass spectrum data, are displayed on the map so as to be distinguished from other peaks.

17. The analysis method with the use of the liquid chromatography/mass spectrometry device according to claim 10, wherein only a peak of the authentic sample and a peak of the sample to be compared which each have a designated difference of the mass-to-charge ratio out of the mass spectrum data, are displayed on the map.
